(19) United States
(12) Patent Application Publication
(10) Pub. No.: US 2011/0065557 A1
(43) Pub. Date: Mar. 17, 2011

(54) CARTON ASSEMBLY HAVING A WATERPROOF LINING

(75) Inventor: Urban C. HIRSCHEY, Cape Vincent, NY (US)

(73) Assignee: Climax Manufacturing Company, Lowville, NY (US)

(21) Appl. No.: 12/950,284

(22) Filed: Nov. 19, 2010

Related U.S. Application Data
(62) Division of application No. 11/802,850, filed on May 25, 2007.
(60) Provisional application No. 60/808,577, filed on May 26, 2006.

(51) Int. Cl. B31B 1/20

(52) U.S. Cl. 493/56

(57) ABSTRACT

A carton, a method and an apparatus for forming a novel carton, having a waterproof lining are disclosed. The carton preferably may include a base portion, leading and trailing end edges, first and second side edges, leading and trailing end flaps, and first and second side flaps. The waterproof lining may be affixed to the carton by an adhesive pattern disposed on the at least a portion of the carton. Upon folding of the flaps about the base portion, a container having a waterproof lining may be formed for retaining objects. The waterproof lining may include a bag and may further include a means for sealing the bag for enclosing wet objects, such as seafood products, therein.

### BACKGROUND OF THE INVENTION

I. Related Applications

The present disclosure claims the right to priority based on U.S. Provisional Patent Application No. 60/808,577 filed on May 26, 2006, which is incorporated herein by reference. p. II. Field of the Invention

The present invention relates to a carton assembly having a waterproof lining. More particularly, the present invention relates to a folded carton, a method of manufacturing a folded carton, and a method for assembling a carton, having a waterproof lining for securing and retaining wet or frozen articles therein.

III. Description of the Related Art

Collapsible cartons have been used across various industries for storing and transporting articles. Specifically, planar material, such as synthetic, cardstock, paperboard, or “cardboard”, has traditionally been cut and perforated to form blanks which are folded into receptacles for retaining various articles. For example, some industries, including manufacturers and retailers, may provide their customers with such receptacles for transporting and/or storing purchased items. These receptacles are generally provided to the customer in any range of assembly, from completely collapsed to fully constructed cartons. Moreover, they are generally provided to the customer as a unitary or two-piece carton, without any accompanying sheets or liners.

In some cases, the articles retained in such cartons contain liquid which may contact and permeate the carton. In the event that these articles include food, such as meat or fish products, whether fresh or frozen, the saturation of the carton by liquids therein (e.g., salt water, oils, etc.) may be undesirable or unsanitary. For example, when ice is used to preserve food products stored in the carton, it is undesirable for melting ice to saturate and impair the structural integrity of the carton. If an item itself is frozen, it may thaw, partially or completely, thereby releasing liquids inside the carton. In another instance, such as when the articles may include inks or other permanent color markings, it is undesirable for the liquids to seep from within the carton to contact, and possibly stain, objects outside of the carton. Furthermore, in some cases, it is undesirable for outside contaminants to contact those articles retained within the carton.

Thus, it is desirable to provide an economical and accessible carton for storing and/or transporting various articles. It is also desirable to retain the articles so as to prevent associated liquids in the container from either penetrating, and/or leaking from, the carton, as well as to prevent outside contaminants from possibly contacting the contents of the carton. It is also desirable that the carton be configured so that a wet or frozen item can be loaded into and sealed in the carton quickly, without adding down-time to a packing assembly line.

### SUMMARY OF THE INVENTION

Accordingly, the present invention is directed to a carton, a method of manufacturing a carton, having a waterproof lining, that substantially overcomes one or more of the problems caused by the limitations and disadvantages of related cartons and methods. The methods of the present invention will provide cartons which, when assembled, will have a convenient waterproof lining, a much lower incidence of unusable cartons due to leakage, a quicker loading capability, and consequently, a lower overall cost, to the carton manufacturer, the carton packer/shipper, and the ultimate purchasers of the packaged items.

To achieve these and other advantages, and in accordance with the purposes of the invention, as embodied and broadly described, it is an object of the invention to provide a carton assembly comprising: a container portion comprising a base portion, defining a plane, said base portion defined by leading and trailing end edges, and first and second side edges; a leading end flap, foldably attached to, and extending from, the leading end edge; a trailing end flap, foldably attached to, and extending from, the trailing end edge; a first side flap, foldably attached to, and extending from, the first side edge; and a second side flap, foldably attached to, and extending from, the second side edge; wherein said leading and trailing end flaps, and first and second side flaps, fold away from the plane to define a container; and a waterproof lining portion fixed to the container portion, configured to provide an enclosure around an object placed in the container.

It is a further object of the invention to provide a method of assembling a carton having a waterproof lining, comprising the steps of: feeding a carton blank in a first direction, the carton blank comprising: a base portion, defining a plane, said base portion defined by leading and trailing end edges, and first and second side edges; a leading end flap, foldably attached to, and extending from, the leading end edge; a trailing end flap, foldably attached to, and extending from, the trailing end edge; a first side flap, foldably attached to, and extending from, the first side edge; and a second side flap, foldably attached to, and extending from, the second side edge; feeding a synthetic sheet under tension in a second direction; cutting a waterproof lining from the synthetic sheet; and affixing the waterproof lining to the carton blank.

It is a still further object of the present invention to provide an apparatus for manufacturing a carton having a waterproof lining, comprising: a means for feeding a carton blank in a first direction, the carton blank comprising: a base portion, defining a plane, said base portion defined by leading and trailing end edges, and first and second side edges; a leading end flap, foldably attached to, and extending from, the leading end edge; a trailing end flap, foldably attached to, and extending from, the trailing end edge; a first side flap, foldably attached to, and extending from, the first side edge; and a second side flap, foldably attached to, and extending from, the second side edge; a means for feeding a synthetic sheet under tension in a second direction; a means for cutting a waterproof lining from the synthetic sheet; a means for folding said leading and trailing end flaps, and first and second side flaps, of the carton blank away from the plane to define a container; and a means for fixing the waterproof lining to the carton blank.

It is a further object of the invention to provide a method for manufacturing a carton with a waterproof lining. A carton blank is provided, comprising a base portion defining a plane, the base portion defined by leading and trailing end edges, and first and second side edges, the carton blank further including a leading end flap, foldably attached to, and extending from, the leading end edge, a trailing end flap, foldably attached to, and extending from, the trailing end edge, a first side flap, foldably attached to, and extending from, the first side edge, and a second side flap, foldably attached to, and extending from, the second side edge. A waterproof liner is fixed to the carton blank. The leading and trailing end flaps, and first and second side flaps are folded upward, away from the plane to define a container. Definition of the container opens the waterproof liner to receive a wet or frozen object. After the object is placed inside the waterproof liner, the liner is sealed shut and the carton flaps are closed.

Preferably, the waterproof liner is a bag. It is further preferable that upon definition of the carton, at least one edge of the waterproof liner overlaps at least one flap of the carton. It is further preferable that the edge of the bag be adhered to the flaps of the container so that, upon definition of the container, the bag is simultaneously opened and held open. It is further preferable that the edge of the bag be adhered to the carton flaps with releasable adhesive.

Additional objects and advantages of the invention will be set forth in the description which follows, and in part will be apparent from the description, or may be learned by practice of the invention. The advantages of the invention will be realized and attained by the process and apparatus particularly pointed out in the written description and claims, as well as the enclosed drawings.

It is to be understood that both the foregoing general description and the following detail description are only exemplary, and are intended to provide further explanation of the invention as claimed.

### BRIEF DESCRIPTION OF THE DRAWINGS

The accompanying drawings are included to provide a further understanding of the invention and are incorporated in and constitute a part of this specification. The drawings illustrate embodiments of the invention and, together with the description, serve to explain the principles of the invention. In the drawings,

FIG. 1 is a side view depicting, schematically, an apparatus for constructing the carton assembly of the present invention;

FIG. 2a is a side view depicting, schematically, a step of applying an adhesive pattern to a carton blank in accordance with the present invention;

FIG. 2b is a perspective view depicting a step of feeding and folding a synthetic sheet in accordance with the present invention;

FIG. 3a is a top view of a portion of the apparatus of FIG. 1 used to reroute the carton blank and affixed waterproof lining;

FIG. 3b is a partial side view of the apparatus depicted in FIG. 3a;

FIGS. 4a-4x are side views depicting a number of configurations of erected cartons with waterproof linings in accordance with the present invention;

FIGS. 5a-5g are top views depicting unerected cartons having various configurations of adhesive patterns in accordance with the present invention;

FIG. 6 is a perspective view depicting a waterproof lining which may be received by the carton of FIG. 5f;

FIG. 7 is a perspective view of the waterproof lining of FIG. 6 disposed within, and adhered to, the carton of FIG. 5f; and

FIG. 8 is a perspective view of the embodiment of FIG. 5g, with the carton assembled, and ready for loading.

### DETAILED DESCRIPTION

Reference will now be made in detail to the present embodiment of the invention, an example of which is illustrated in the accompanying drawings. Wherever possible, the same reference numbers will be used throughout the drawings to refer to the same or like parts.

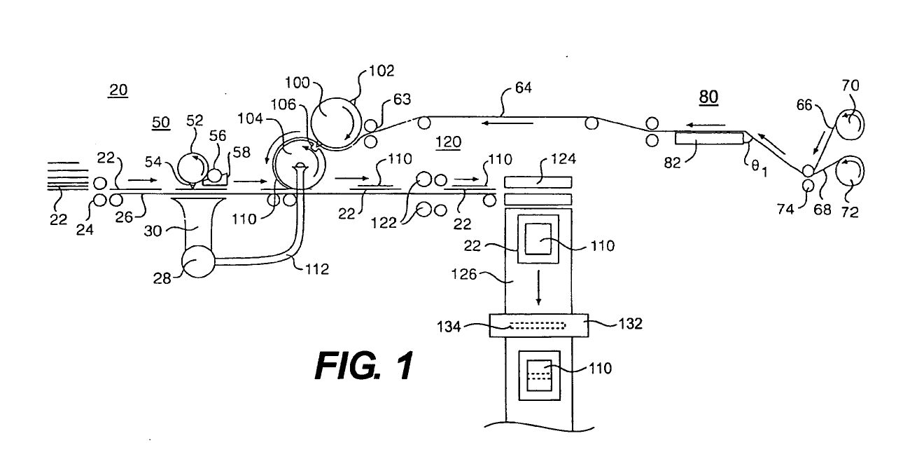

The exemplary embodiment of an apparatus for manufacturing a carton assembly of the present invention is shown in FIG. 1 and is designated generally by reference numeral 20. In accordance with the invention, a method of constructing a carton having a waterproof lining comprises a step of feeding a carton blank in a first direction, the carton blank comprising: a base portion, defining a plane, said base portion defined by leading and trailing end edges, and first and second side edges; a leading end flap, foldably attached to, and extending from, the leading end edge; a trailing end flap, foldably attached to, and extending from, the trailing end edge; a first side flap, foldably attached to, and extending from, the first side edge; and a second side flap, foldably attached to, and extending from, the second side edge; feeding a synthetic sheet under tension in a second direction; cutting a waterproof lining from the synthetic sheet; and affixing the waterproof lining to the carton blank.

As broadly embodied herein, and referring to FIG. 1, a plurality of carton blanks 22 are provided, each carton blank 22 being fed between a pair of nip rolls 24 of a standard carton blank feeding apparatus, that is well known in the box-processing art. It is contemplated that the carton blanks 22 may be fed in any orientation. For example, they may be fed with either their longitudinal or transverse axes parallel to the direction of travel. Accordingly, they may be processed, such as with adhesive, in a desired configuration. The nip rolls 24 of the carton blank feeding apparatus feed the carton blanks 22 in sequential order onto a conveyor belt 26, with a set spacing between each carton blank 22. The spacing between the carton blanks can be varied depending on the desired feed rate. The feed rate of the blank feeding apparatus can be adjusted by increasing the speed of the nip rolls 24.

Preferably, a vacuum is applied to the conveyor belt 26 to hold the carton blanks 22 firmly against the conveyor belt 26. Accordingly, a vacuum pump 28 is provided with a manifold 30 leading to the bottom of the conveyor belt 26. Conveyor belt 26 is provided with a plurality of perforations in order to allow suction from the vacuum pump 28 to draw each carton blank 22 firmly against the belt.

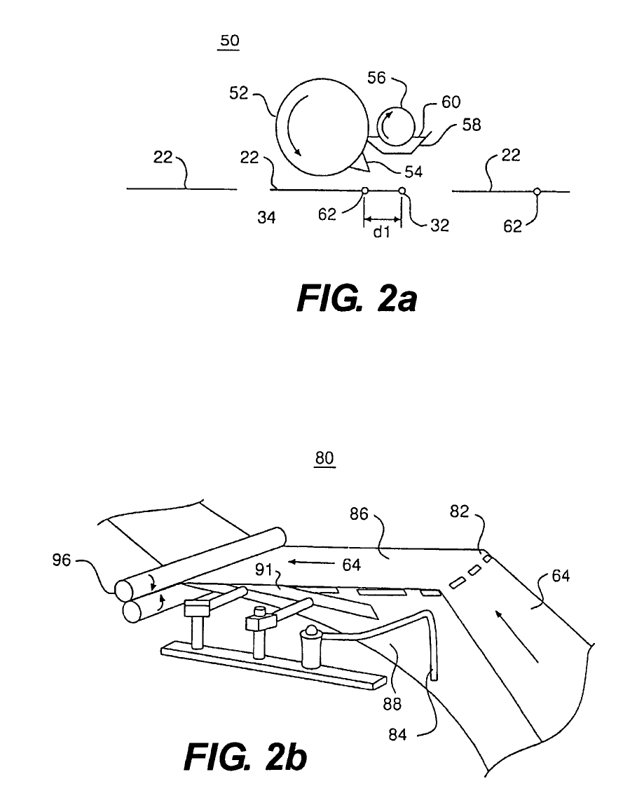

Preferably the method may include a step of applying adhesive to a selected position on the surface of each carton blank 22. As broadly embodied herein, and referring to FIGS. 1 and 2a, an adhesive applying section 50 preferably includes a rotating drum 52. A wedge 54, made of a resilient material such as rubber or hard synthetic, preferably extends lengthwise along the surface of the drum 52. An adhesive supply drum 56 rotates alongside the drum 52, passing through a reservoir 58 containing a liquid adhesive 60. In some embodiments, an adhesive 60 is a non-permanent, release-type adhesive. Adhesive supply drum 56 picks up the adhesive 60 from the reservoir 58 and applies it to the apex of wedge 54.

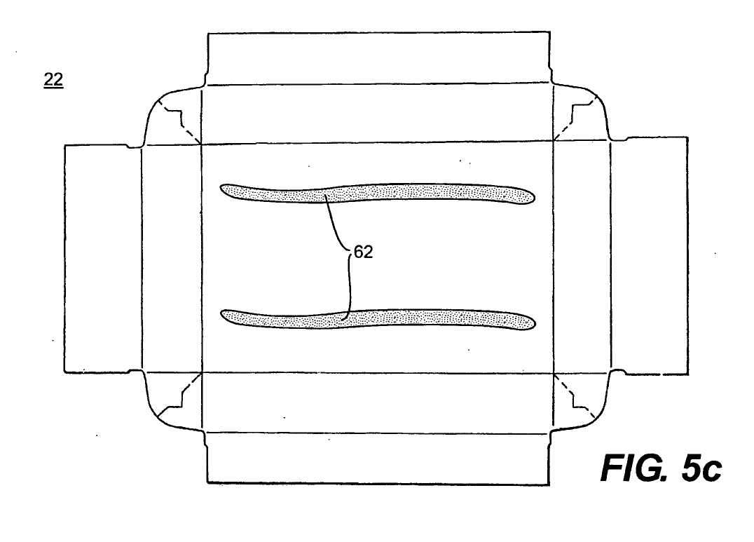

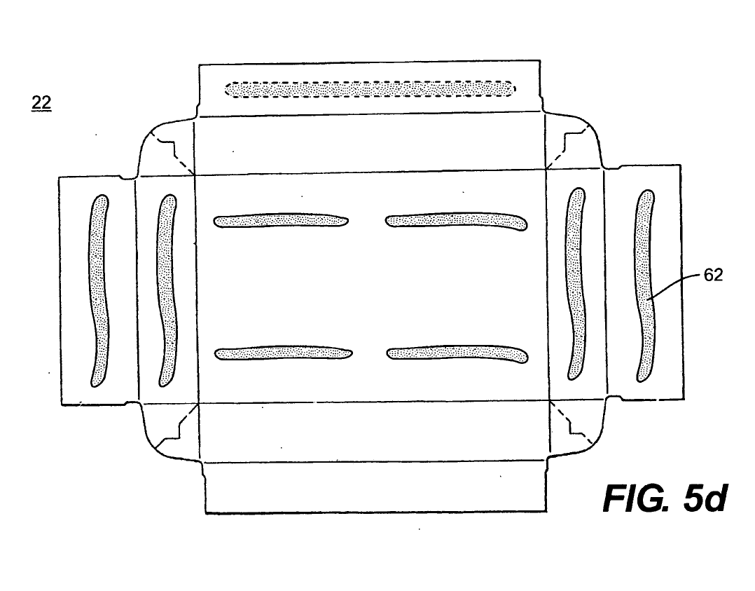

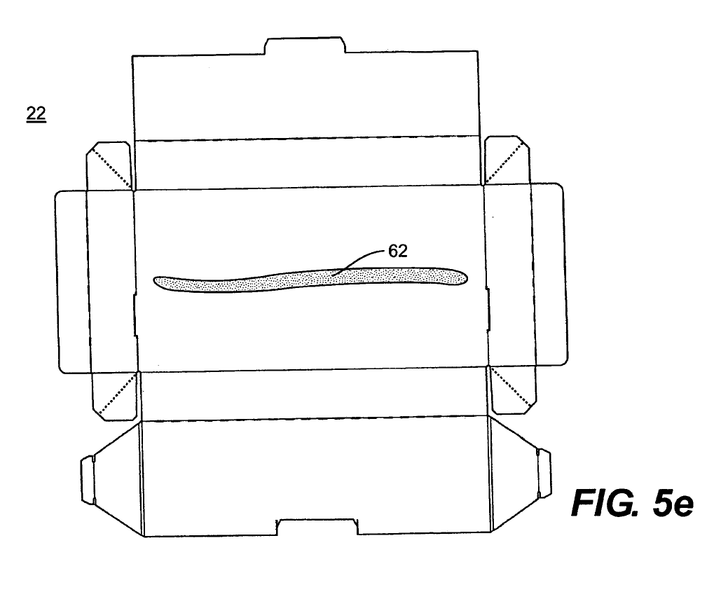

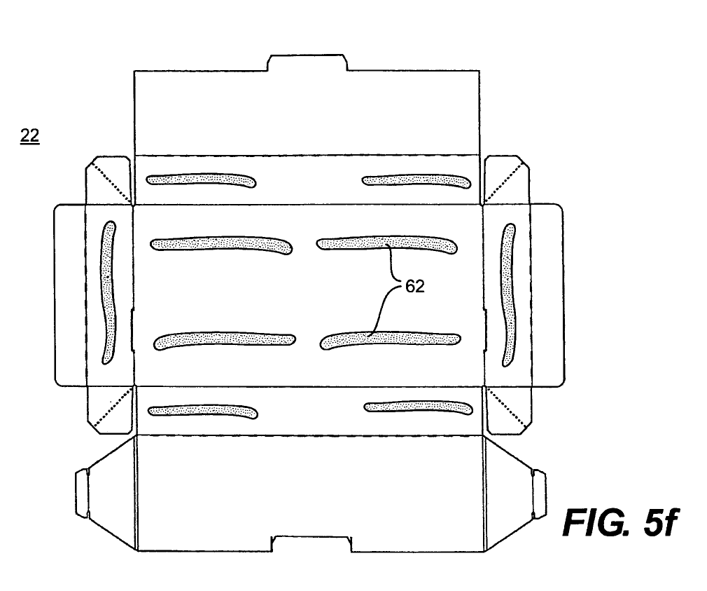

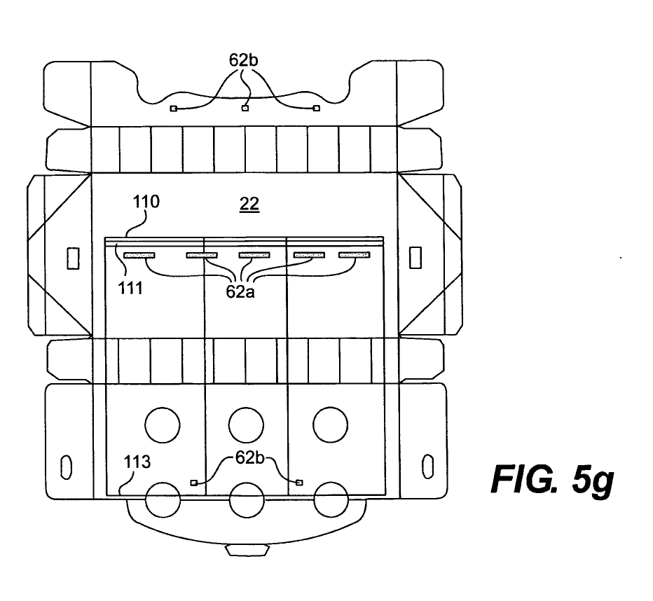

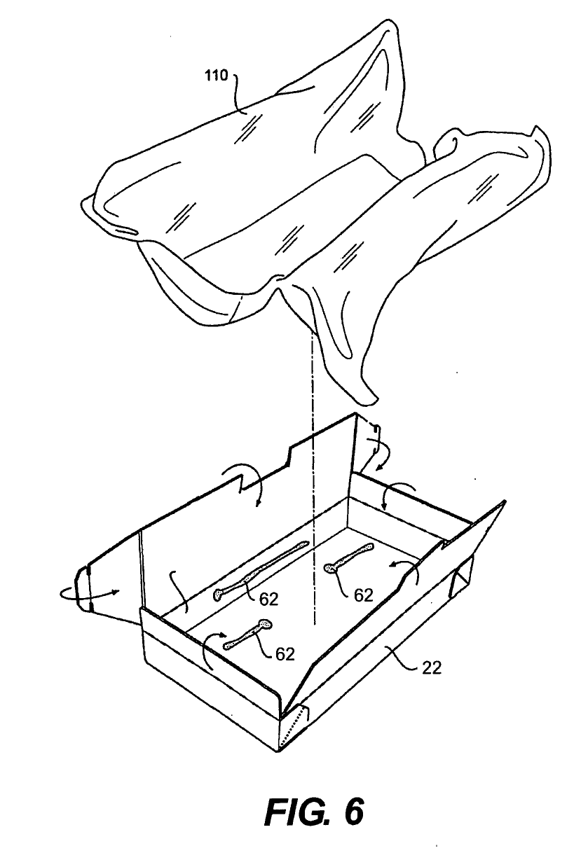

Preferably, rotation of the drum 52 is metered to match the feed rate of the carton blanks 22 on the conveyor belt 26. Hence, the rotational speed of the drum 52 can vary as the carton feed rate varies. As will be understood with reference below to FIGS. 5a-g, it is within the scope of the invention to apply the adhesive in a plurality of selected locations on the carton surface so as to result in an adhesive pattern 62 disposed in a desired configuration on each carton blank 22.

Thus, the adhesive applying step, when utilized, may be varied. For example, use of a wedge 54 with one or more separations along its length may be desired in order to apply a broken-line adhesive pattern 62 on the surface of each carton blank 22. The wedge 54 also can be arranged to define a straight line, a circle, or another pattern, geometric shape, or free forming per customer requirements. The relative position of the adhesive pattern 62 on the surface of a respective carton blank 22 also may be varied. Furthermore, the use of different adhesives having different strengths, e.g., permanent adhesives and temporary adhesives, is contemplated. Additional wedges 54 also may be mounted on the drum 52 to provide additional variations of adhesive patterns 62. In certain cases, no adhesive may be desired. Hence, in an alternative embodiment, the adhesive applying step may be omitted altogether.

In accordance with a method of the invention, a step is provided of feeding a synthetic sheet 64 under tension. As broadly embodied herein, and referring to FIG. 1, nip rolls 63 preferably rotate and draw the synthetic sheet 64 under tension. As shown in FIG. 1, the direction of travel of the synthetic sheet 64 preferably is in a second direction opposite to the direction in which the carton blanks 22 are fed. However, the invention is not limited to this direction of travel. The synthetic sheet 64 can be fed in the same direction as the carton blanks 22, at a 90° angle to the carton blanks, or in any other direction relative to the carton blanks 22. Moreover, the rate of feed of the synthetic sheet 64 can be varied by increasing or decreasing the speed of rotation of the nip rolls 63.

As broadly embodied in FIG. 1, the synthetic sheet 64 could comprise a combination of two separate synthetic sheets 66, 68, which are fed from synthetic rolls 70, 72, respectively, to two nip rolls 74. The synthetic rolls 70, 72 preferably rotate freely, with the synthetic sheets 66, 68 being pulled by the rotation of the nip rolls 74. This type of double sheet synthetic may be preferable for increasing the strength and/or waterproof characteristics of the lining. However, the invention is not limited to a double sheet synthetic. A single sheet, or any multiple sheet is within the scope of the invention, simply by adding or deleting synthetic rolls. In one embodiment, a double synthetic sheet may be advantageous for creating a plurality of synthetic bags, for use as the waterproof lining 110 in the cartons 22. For instance, if sealed along their first and second sides, the synthetic sheets may form a tube, which may be cut and sealed in certain locations along its length to create the desired bags. Alternatively, a synthetic tube, which has been extruded from an annular die, may be formed into bags by preferably cutting and sealing the continuous synthetic tube in certain locations along its length.

The synthetic sheet 64 and the waterproof lining 110, or bag, formed therefrom may be made from any type of synthetic material, such as waxed paper, aluminum foil, or any variety of plastics, rubbers, polyethylenes (e.g., PET), polypropylenes, polyvinyls, and the like. In one embodiment, the synthetic sheet 64 preferably is microwavable and/or ovenable, so as to also provide a convenient cooking receptacle for food products.

In accordance with one embodiment of the present invention, a step may be provided for folding the synthetic sheet 64. The resulting folded synthetic sheet, tube, or bag can have a variety of configurations for providing a waterproof lining consistent with the present invention, as discussed below.

As broadly embodied herein, and referring to FIGS. 1 and 2b, a folding station 80 includes a horizontal platform 82, over which the synthetic sheet 64 is draped and pulled. The synthetic sheet 64 defines an angle θᵢ with horizontal platform 82, which preferably is approximately 47° . It has been determined that this angle 8, provides optimum tension to the synthetic sheet during the feeding and folding stages to prevent stretching and/or tearing of the synthetic sheet 64.

As broadly embodied in FIG. 2b, a folding bar 84 is provided to fold the synthetic sheet 64, thereby creating a base portion 86 and a first side flap 88. FIG. 2b only depicts one side of the folding station 80. If desired, a similar folding bar 84 (not shown in FIG. 2b) can be provided on the opposite side, thereby creating a second side flap 90 (not shown in FIG. 2b). The interaction of the folding bar 84 and the horizontal platform 82 creates a synthetic sheet 64 having at least one fold.

As broadly embodied in FIG. 2b, a cam or “guide plough” 91 can be optionally provided beneath the horizontal surface 82 to crease the side of the first side flap 88. Cam 91 creates a third crease 93, dividing the first side flap 88 into a pair of subflaps 92 and 94. It is further possible to fold the other flap 90 into a pair of subflaps joined by a fourth crease (not shown), by providing another cam or “guide plough” on the opposite side of horizontal surface 82.

The invention is not limited to any particular arrangement of creases and folds in synthetic sheet 64. It is not even required that the synthetic sheet have two flaps. In some cases, only a single flap will be required, defining the base portion of the synthetic by a first crease and an opposite edge. In fact, in some cases, it is preferable to retain the synthetic sheet 64 in a flat configuration without any intended creases, folds or flaps. In such an embodiment, the synthetic sheet 64 preferably is fixed to a, yet un-folded, carton blank 22 while in its flat configuration.

Alternatively, additional creases and flaps may be provided in the synthetic sheet 64, in order to create any desired configuration to the waterproof lining, by adding additional folding structure to folding station 80. The invention therefore is not limited to the number of folds that can be provided in the synthetic sheet. The number of folds, flaps and subflaps will be a function of customer preference. To complete the folding step, a pair of nip rolls 96 may be provided, as broadly depicted in FIG. 2b, to firmly press the folded synthetic sheet 64 together for further processing.

The presently disclosed method preferably also includes the step of cutting the synthetic sheet 64, as well as an apparatus for performing the cutting step. As broadly embodied herein, and referring to FIG. 1, a rotating cutting cylinder 100 is provided, having a plurality of cutting blades 102 projecting therefrom, for cutting the synthetic sheet 64 into sections having leading and trailing end edges, and a second length between the leading and trailing end edges. Preferably, the number of cutting blades 102 is adjustable.

As embodied in FIG. 1, the cutting cylinder 100 preferably rotates alongside a rotating vacuum drum 104, such that one of the cutting blades 102 contacts an anvil 106. Synthetic sheet 64, after passing between the nip rolls 63, threads between the cutting cylinder 100 and vacuum drum 104. Cutting blade 102 then preferably slices a waterproof lining 110 from synthetic sheet 64.

As broadly embodied in FIG. 1, each waterproof lining 110, after being cut from the synthetic sheet 64, is held against the surface of the vacuum drum 104 by the suction of the vacuum pump 28 via the vacuum manifold 112 and a plurality of apertures in the surface of vacuum drum 104. Each waterproof lining 110 is then pressed between the vacuum drum 104 and its corresponding carton blank 22. When adhesive has been applied to the carton blanks 22, each waterproof lining 110 adheres to the adhesive pattern 62 of each carton blank 22. In some embodiments, each waterproof lining 110 may be adhered to its corresponding carton blank 22 by varying degrees of permanence, depending on the location and type of adhesive used. For example, in one embodiment, a base portion of the waterproof lining 110 is permanently adhered to the carton blank, whereas first and second side flaps, and leading and trailing end flaps, are releasably attached to respective flaps of the unassembled carton 22.

In accordance with the invention, a step may be provided for folding leading and trailing end flaps of each carton blank 22, and first and second side flaps of the carton blank. As broadly embodied in FIG. 1, each carton blank 22 with affixed waterproof lining 110 proceeds on the conveyor belt 26 to a flap folding section 120. The flap folding section 120 includes a series of rollers 122, as are well known in the art, for lifting and folding the box flaps. In the event that the waterproof lining 110 has been affixed to and/or over the flaps of the carton blank 22, the flaps of the waterproof lining 110 may be folded upwards with the flaps of the carton blank 22. If the waterproof lining 110 is in its folded configuration over only the base portion 40 of the carton blank 22, it may remain folded in the center of the carton blank 22 until expanded by an operator or customer.

After passing through the rollers 122, the folded carton blank 22 and waterproof lining 110 may pass into a right angle turn section 124, where the carton blank 22 and waterproof lining 110 are turned 90° and sent down the conveyor belt 126 for final processing. This step occurs only in a right-angle machine. In other cases, where no right-angle turn is required, the right angle turn section 124 can be eliminated.

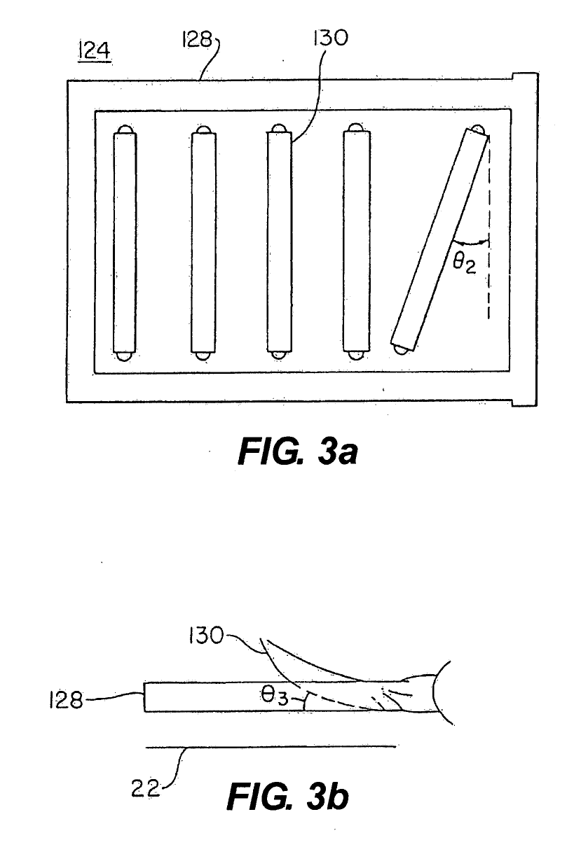

When a right angle turn is required, and as shown in FIGS. 3a and 3b, the right angle turn section 124 preferably includes a frame 128 and a plurality of slats 130 bolted to the frame. Preferably, at least one of the slats 130 is tilted at an angle θ₂, of approximately 15° from the vertical. In addition, it is preferred that the slats 130 are tilted at an angle θ₃ of approximately 5-10° from the horizontal. It has been found that these angles of inclination for the slats 130 are ideal for enabling the slats 130 to hold the waterproof lining 110 down during the right angle turn of the carton, while at the same time avoiding stretching or tearing of each waterproof lining 110.

In the event that the waterproof lining 110 requires heat sealing, a heat sealing station 132 may be provided. The heat sealing station 132 may include a heating element 134, which lowers onto the waterproof lining 110, thereby heating it to create a seal in a preferred location, such as along the opening of a bag-shaped waterproof lining 110. One or more heat sealing stations 132 may be provided in various locations along the manufacturing line of FIG. 1. For example, sealing means may be provided before or after the cutting cylinder 100.

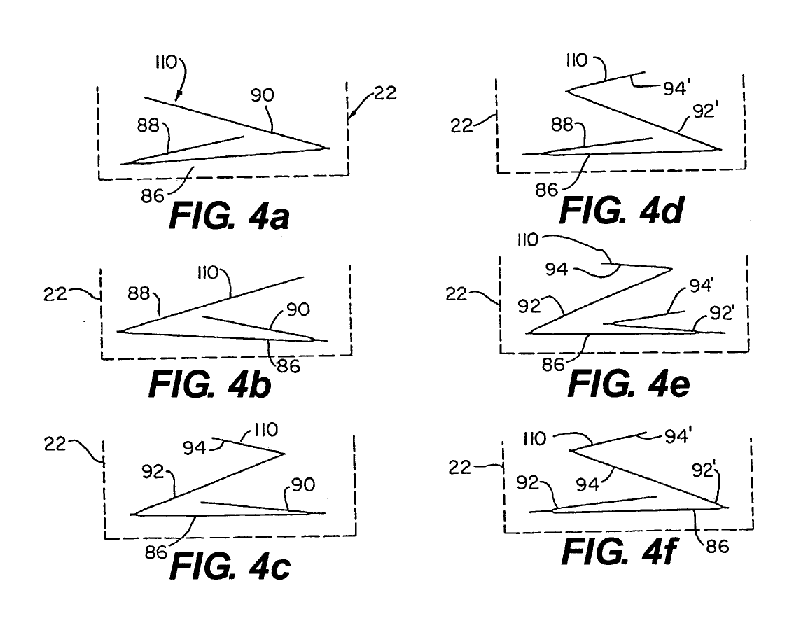

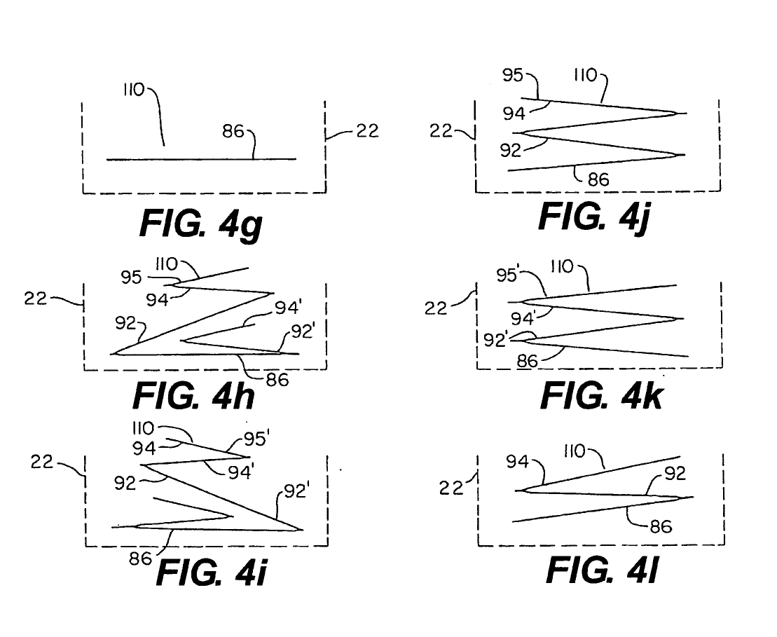

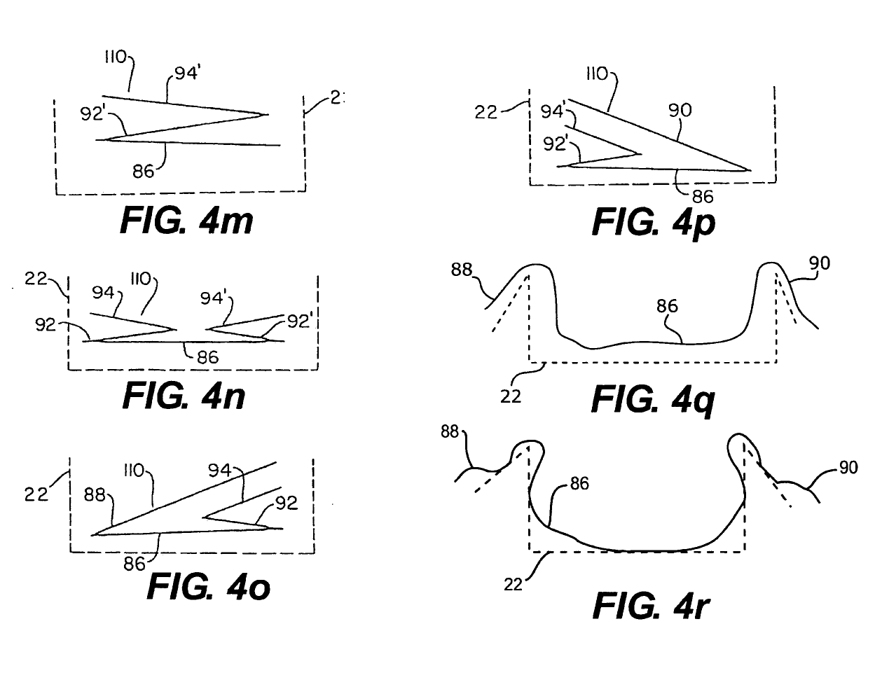

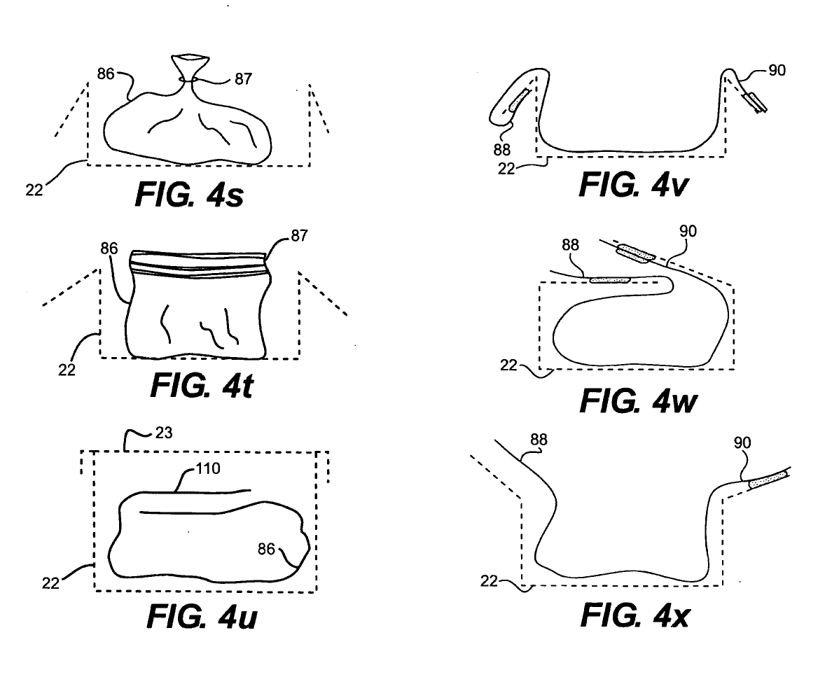

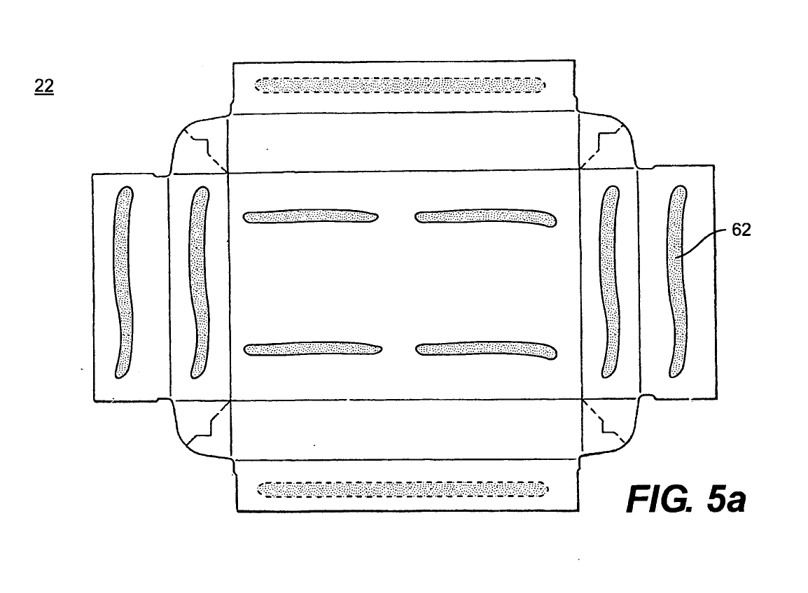

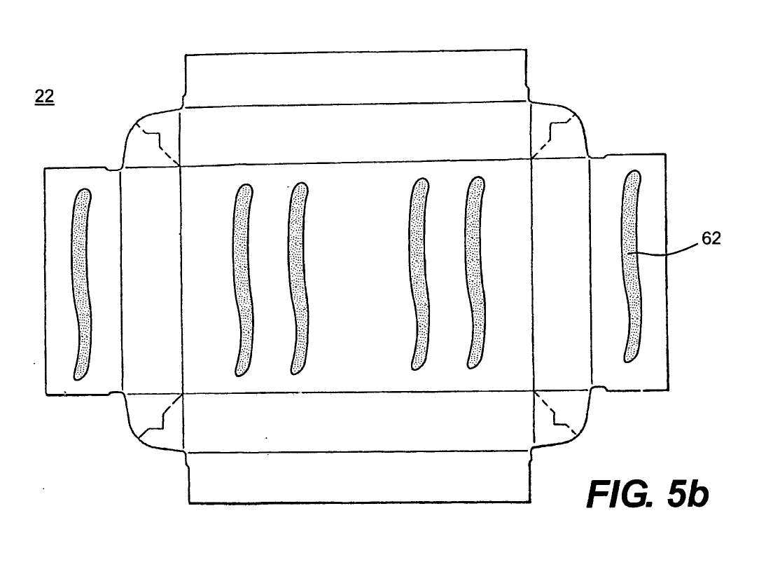

Various folded or non-folded configurations of the waterproof lining 110 and the carton 22 currently envisioned by the inventors are depicted broadly in FIGS. 4a-4x. Each configuration will be discussed briefly below.

FIG. 4a depicts a simple fold comprising a base 86, first side flap 88, and second side flap 90. In this configuration, the second (or right) side flap 90 lies has over the first (or left) side flap 88.

FIG. 4b depicts a simple fold which is the reverse of the configuration depicted in FIG. 4a.

FIG. 4c depicts another embodiment comprising a base 86, side flap 90, and side flap 88 folded into subflaps 92 and 94.

FIG. 4d depicts a fold which is the reverse of the configuration depicted in FIG. 4c, with the sideflap 90 folded into side flaps 92′ and 94′.

FIG. 4e depicts a Z-fold, comprising a base 86. Each side flap has been folded into a pair of subflaps 92, 94, and 92′, 94′.

FIG. 4f depicts a fold which is the reverse of the configuration depicted in FIG. 4e.

FIG. 4g depicts a configuration in which the folding bar and guide plough have been removed, so that no folds or creases are applied to the waterproof lining 110. In this configuration, the waterproof lining 110 consists only of a base portion 86.

FIG. 4h depicts a configuration created by attaching yet another guide plough to one side of the folding station in order to create a third subflap 95.

FIG. 4i depicts a configuration which is the reverse of the configuration depicted in FIG. 4h.

FIG. 4j depicts an accordion fold, created by removing the folding bar and guide ploughs from one side of the folding station, and attaching one folding bar and two guide ploughs to the other side of the folding station. This folding station arrangement creates a waterproof lining having a base section 86, with no side flaps on one side, and the other side folded into three subflaps 92, 94 and 95.

FIG. 4k depicts a configuration which is the reverse of the configuration depicted in FIG. 4j.

FIG. 4l depicts a fold created by removing the folding bar and guide ploughs from one side of the folding station, and attaching one folding bar and one guide plough to the other side of the folding station. This folding station arrangement creates a waterproof lining having a base 86, with no side flap on one side, and the other side folded into two subflaps 92 and 94.

FIG. 4m depicts a configuration which is the reverse of the configuration depicted in FIG. 41.

FIG. 4n depicts a “narrow Z-fold” in which a folding bar and guide plough are provided on each side of the folding station, or that each side flap is folded into subflaps 92, 94, and 92′, 94′.

FIG. 4o depicts a “left arrow” configuration including a base 86, one side flap 88, and the other side flap folded into subflaps 92, 94.

FIG. 4p depicts a configuration which is the reverse of the configuration depicted in FIG. 4o.

FIG. 4q depicts a configuration in which at least the first side flap 88 and second side flap 90 are disposed over flaps of the carton 22.

FIG. 4r depicts a configuration in which at least the first side flap 88 and second side flap 90 are disposed over and adhered to flaps of the carton 22. In this embodiment, the waterproof lining 110 is arranged to spread automatically upon opening the flaps of the carton 22, to protect them from contact with liquid.

FIGS. 4s-t depict a configuration in which the base portion 86 of the waterproof lining 110 comprises a bag, such as a polyethylene bag, which may be sealed by any suitable sealing means 87, such as a tie, melted seal, adhesive, “zip-lock”, plurality of folds, clasps, or other sealing mechanisms.

FIG. 4u depicts a configuration of the carton 22 in which a lid portion 23 is configured to fit over and enclose the carton 22. Moreover, the waterproof lining 110 is folded over itself to enclose any objects therein.

FIG. 4v depicts a configuration of the carton 22 in which a first side flap 88 of the waterproof lining 110 is adhered to an outer surface of a flap of the carton 22. A second side flap 90 of the waterproof lining 110 is adhered to an inner surface of another flap of the carton 22. In this embodiment, the waterproof lining 110 is preferably arranged with adhesive on one or more surfaces so as to create a seal upon closing the flaps of the carton 22.

FIG. 4w depicts the carton 22 and waterproof lining 110 of FIG. 4v in a nearly closed and sealed position. In this embodiment, adhesive disposed on the waterproof lining 110 itself, preferably creates a waterproof, retaining seal.

FIG. 4x depicts a configuration of the carton 22 and waterproof lining 110 in which only the second side flap 90 of the waterproof lining 110 is adhered to a flap of the carton 22. The first side flap 88 is preferably free for manipulation by a user but capable of being adhered to a flap of the carton 22, in any desired configuration, if preferably provided with adhesive.

FIGS. 5a-d depict various embodiments of the carton 22, each having a different adhesive pattern 62. For example, each adhesive pattern 62 may have a different arrangement of lines, strips, or dots of adhesive 60 disposed on the surface of the carton 22. Specifically, each adhesive pattern 62 may include any preferable arrangement of adhesives on the base portion and/or flaps of the carton. Moreover, various portions of each adhesive pattern 62 may have varying types of adhesive so as to be either permanent or releasable in adhesive strength.

FIGS. 5e-f depict an alternative style of carton 22 having still further arrangements of adhesive patterns 62. In the embodiment of FIG. 5e, the bag is preferably affixed to the carton 22 by a single strip of adhesive 62. The single strip of adhesive 62 is preferably a strong adhesive that permanently affixes the bag to the carton 22. By this embodiment, the bag is only secured to the carton 22 by a single location at the bottom of the bag. Alternatively, in those instances in which the bag is affixed to the carton 22 by a number of adhesive locations, including those on the flaps of the carton 22, as depicted in FIG. 5f, the bag may be held open by the opening of the flaps.

FIG. 5g depicts an alternative style of a one-piece carton 22 having still further arrangements of adhesive 60. In this embodiment, the waterproof lining 110 preferably is a gusseted tube of poly that has been cut-off and closed at its bottom end by a heat seal 111, and adhered to the carton 22 by a permanent adhesive pattern 62a. The waterproof lining 110 is also preferably secured to at least one set of non-permanent, releasable, adhesive patterns 62b. For example, suitable releasable adhesives preferably include hot melt adhesives, curable adhesives, pressure sensitive adhesives, epoxies, acrylic adhesives, and any other natural or synthetic non-permanent adhesive.

The releasable adhesive patterns 62b may be disposed on the inside and/or outside faces of the carton flaps. As illustrated, the waterproof lining 110 is adhered to a set of releasable adhesive patterns 62b adjacent to an open end 113 of the waterproof lining 110. Accordingly, the waterproof lining 110 preferably includes a bag held open by flaps of the carton 22 for the convenient loading and unloading of food and other items. For example, the bag may be releasably affixed to flaps of the carton 22 with releasable adhesive. Moreover, the flaps of the carton 22 may be prevented from coming in contact with fluids or other contents of the bag of the waterproof lining 110, such as during loading and unloading of the contents. Such a waterproof lining 110, as embodied in a bag, may be particularly useful in retaining and transporting seafood, such as shellfish and other pointed, and potentially abrasive objects. Moreover, such a bag may be especially reinforced for preventing the trespass of associated liquids into and through the carton 22. In one embodiment, after loading, the open end 113 may be released from the releasable adhesive patterns 62b to be secured for sealing of the bag by other means, as described above, prior to shipping or storage.

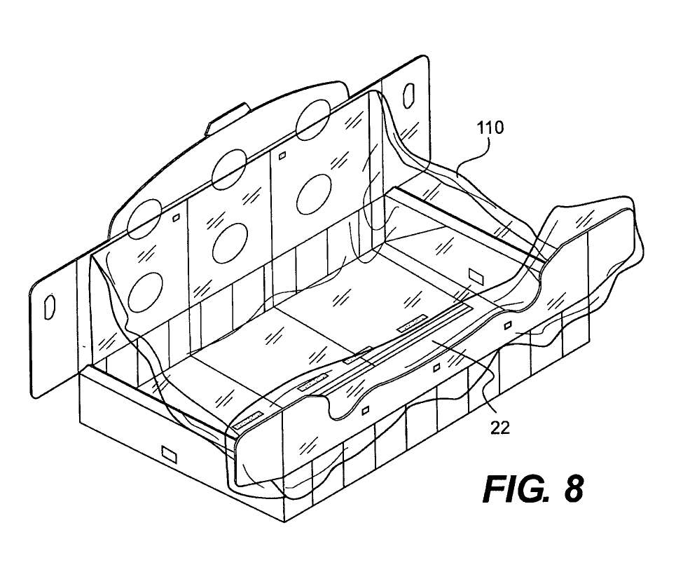

Referring to FIG. 8, when a user opens a carton 22 to its upright, assembled position, the bag is simultaneously pulled upward to its upright and open position, ready to receive a product. After insertion of the product into the open bag, the bag can be closed and sealed and the carton can be closed. Hence, the packing of a carton 22 with wet items, such as meat or seafood, can be performed on a packing assembly line, efficiently and without shutting down the line.

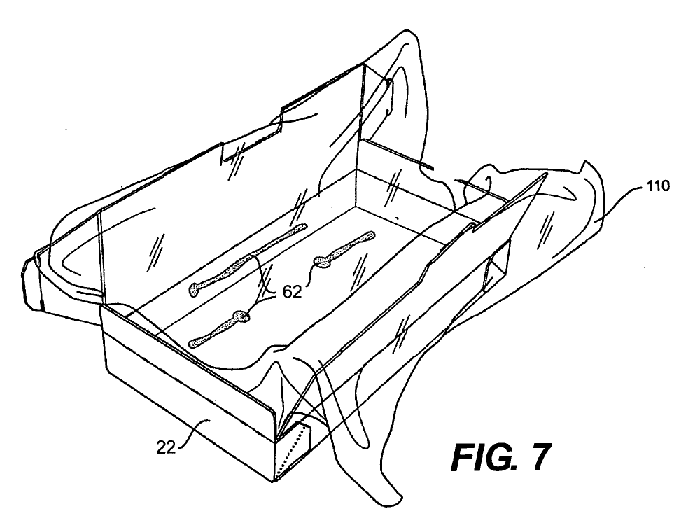

As broadly depicted in FIG. 6, a waterproof lining 110 is illustrated in a position to be received by a carton 22. The waterproof lining 110 is illustrated as adhered to the carton 22 in FIG. 7. The waterproof lining 110 may be capable of encapsulating an item and retaining liquids within the lining, upon enclosure of the object therein.

In each of the embodiments disclosed and depicted herein, the carton 22 is not limited to any particular material or dimensions. For example, in the event that the product to be shipped includes shellfish, or a similar product with points and sharp edges, relatively thick or foamed board may be used to prevent shells and claws from piercing the walls of the carton. It is further contemplated that cartons 22 consistent with the present invention preferably may include any other variety of carton, box, or crate, and any configuration of reinforcements. For example, suitable cartons 22 may include metal wiring, synthetic brackets, corner protectors, corrugations or other braces. Other materials may be selected for other applications, as desired.

The process and apparatus described above allows preparation of carton blanks having a prefolded waterproof lining or waterproof bag. The carton blank can be unfolded and assembled into a carton having a folded waterproof lining or a waterproof bag, already inserted and ready to be opened quickly. The novel method of applying adhesive to the carton blank surface, and of using release-type adhesive, results in the waterproof lining being fixed in place, but in some embodiments, being easily removable if the customer does not want a waterproof lining. The novel method of folding the synthetic sheet serves to prevent damage to the synthetic sheet during the preparation process. When a right angle machine is used, the novel use of angled slats in the right angle turn section also prevents damage to the waterproof lining during the preparation process.

The above-described apparatus and process consequently produce superior carton blanks with pre-adhered waterproof linings or bags, with far less waste, and consequently a lower cost.

The foregoing description of preferred embodiments of the invention has been presented for purposes of illustration and description. It is not intended to be exhaustive or to limit the invention to the precise form disclosed, and modifications and variations are possible in light of the above teachings, or may be acquired from practice of the invention. The embodiments were chosen and described in order to explain the principles and the practical application of the invention, to enable one skilled in the art to utilize the invention in various embodiments and with various modifications as are suited to the particular use contemplated. It is intended that the scope of the invention be defined by the claims attached hereto, and their equivalents. Having thus described the invention with particular reference to the preferred forms thereof, it will be obvious that various changes and modifications can be made therein without departing from the spirit and scope of the present invention as defined by the appended claims.

1-17. (canceled)

18. A method of manufacturing a carton having a waterproof lining, comprising the steps of:
feeding a carton blank in a first direction, the carton blank comprising: a base portion, defining a plane, said base portion defined by leading and trailing end edges, and first and second side edges; a leading end flap, foldably attached to, and extending from, the leading end edge; a trailing end flap, foldably attached to, and extending from, the trailing end edge; a first side flap, foldably attached to, and extending from, the first side edge; and a second side flap, foldably attached to, and extending from, the second side edge;
feeding a synthetic sheet under tension in a second direction;
cutting a waterproof lining from the synthetic sheet; and
affixing the waterproof lining to the carton blank.

19. The method of claim 18, further comprising a step of applying a pattern of adhesive to selected positions of the carton blank.

20. The method of claim 19, wherein the waterproof lining is affixed to the carton blank by pressing the waterproof lining against the pattern of adhesive on the carton blank.

21. The method of claim 18, further comprising a step of folding said leading and trailing end flaps, and first and second side flaps, of the carton blank away from the plane to define a container.

22. The method of claim 21, wherein upon definition of the container by folding the flaps away from the plane, at least a portion of the lining overlaps at least one of the flaps of the container portion.

23. The method of claim 18, wherein upon affixing the waterproof lining to the carton blank, at least a portion of the lining overlaps at least one of the flaps of the container portion.

24. The method of claim 18, further comprising the step of enclosing an object in the waterproof lining.

25. The method of claim 24, wherein the object enclosed in the waterproof lining comprises seafood.

26. The method of claim 18, wherein the waterproof lining is a bag, and the method further comprises the step of sealing the bag shut after enclosing at least one object in the bag.

27. The method of claim 18, wherein the step of affixing the waterproof lining to the carton blank comprises releasably affixing the waterproof lining to the carton blank.

28. The method of claim 18, wherein the step of affixing the waterproof lining to the carton blank comprises both releasably and permanently affixing the waterproof lining to the carton blank.

29. The method of claim 21, wherein the waterproof lining is a bag, and wherein upon definition of the container by folding the flaps away from the plane, the bag is held in an open position.

30-39. (canceled)
